(19) United States
(12) Patent Application Publication
(10) Pub. No.: US 2019/0197406 A1
(43) Pub. Date: Jun. 27, 2019

(54) NEURAL ENTROPY ENHANCED MACHINE LEARNING

(71) Applicant: Microsoft Technology Licensing, LLC, Redmond, WA (US)

(72) Inventors: Bita Darvish Rouhani, Redmond, WA (US); Douglas C. Burger, Bellevue, WA (US); Eric S. Chung, Woodinville, WA (US)

(21) Appl. No.: 15/853,458

(22) Filed: Dec. 22, 2017

(51) Int. Cl. G06N 3/08; G06F 15/18

(52) U.S. Cl. CPC G06N 3/082; G06F 15/18

(57) ABSTRACT

A computer implemented method of optimizing a neural network includes obtaining a deep neural network (DNN) trained with a training dataset, determining a spreading signal between neurons in multiple adjacent layers of the DNN wherein the spreading signal is an element-wise multiplication of input activations between the neurons in a first layer to neurons in a second next layer with a corresponding weight matrix of connections between such neurons, and determining neural entropies of respective connections between neurons by calculating an exponent of a volume of an area covered by the spreading signal. The DNN may be optimized based on the determined neural entropies between the neurons in the multiple adjacent layers.

### BACKGROUND

A deep neural network (DNN) in machine learning has an input and output layers with multiple hidden layers between the input and output layers. The hidden layers may be thought of as having multiple neurons that make decisions based on features identified from labeled inputs to the input layer. During supervised training of the DNN, the neurons learn and are given weights. The absolute value of the weights has been a key indicator of the importance of a neuron, also referred to as a synapse, and is used to prune a trained network in an effort to reduce computational burdens of the DNN. Pruning involves removing neurons that do not appear to be important in achieving accurate output from the DNN. The absolute value of the weights has also been used in regularizing neural networks to improve accuracy and in quantizing deep learning (DL) models.

### SUMMARY

A computer implemented method of optimizing a neural network includes obtaining a deep neural network (DNN) trained with a training dataset, determining a spreading signal between neurons in multiple adjacent layers of the DNN wherein the spreading signal is an element-wise multiplication of input activations between the neurons in a first layer to neurons in a second next layer with a corresponding weight matrix of connections between such neurons, and determining neural entropies of respective connections between neurons by calculating an exponent of a volume of an area covered by the spreading signal. The DNN may be optimized based on the determined neural entropies between the neurons in the multiple adjacent layers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block representation of training a DL network to form a DL model by us of a training dataset according to an example embodiment.

FIG. 2 is a block representation of a DL model illustrating variance of each Gaussian distribution that indicates uncertainty in a particular connection according to an example embodiment.

FIG. 3A is a graph showing various Gaussian distributions versus variance according to an example embodiment.

FIG. 3B is a chart illustrating characteristics of a first benchmark dataset according to an example embodiment.

FIG. 3C is a chart illustrating characteristics of a first benchmark dataset according to an example embodiment.

FIG. 4 is a graph illustrating sorted absolute value of the weights versus a weight index in an output layer of the first benchmark according to an example embodiment.

FIG. 5 is a graph illustrating sorted entropy of weights versus a weight index in an output layer of the second benchmark according to an example embodiment.

FIG. 6 is a graph illustrating the absolute value of a weight and its entropy are not necessarily correlated according to an example embodiment.

FIG. 7 is a graph illustrating a ranking of the weights based on their entropy at curve and absolute value at and dividing the sorted weights into ten different buckets according to an example embodiment.

FIG. 8 is a pseudocode representation of a greedy layer-wise pruning algorithm according to an example embodiment.

FIG. 9A is a bar chart showing model compression in each layer of the first benchmark after sparse retraining to recover original accuracy according to an example embodiment.

FIG. 9B is a bar chart showing the number of retraining epochs, or sessions used to recover the original accuracy after pruning each layer according to an example embodiment.

FIG. 10 is a bar chart illustrating the result of pruning the second benchmark using the entropic approach according to an example embodiment.

FIG. 11A is a bar chart illustrating dimensionality reduction of the second benchmark based on different levels of entropic thresholding according to an example embodiment.

FIG. 11B is a bar chart illustrating the number of retraining epochs required to fully recover the original accuracy after thinning with different entropic thresholds according to an example embodiment.

FIG. 11C is a bar chart illustrating the obtained accuracy after thinning and retraining the pruned network at different entropic thresholds according to an example embodiment.

FIG. 12A is a bar chart illustrating at a maximum pruning rate per layer while enforcing a particular numerical format according to an example embodiment.

FIG. 12B is a bar chart illustrating a number of re-training epochs to fully recover the original accuracy according to an example embodiment.

FIG. 13 is a flowchart illustrating a method of training a DNN and determining entropic measurements for neuron connections in intermediate and final forms of the resulting model according to an example embodiment.

FIG. 14 is a flowchart illustrating a second method of optimizing the DNN according to an example embodiment.

FIG. 15 is a flowchart illustrating a second method of optimizing the DNN according to an example embodiment.

FIG. 16 is a flowchart illustrating a second method of performing regularization according to an example embodiment.

FIG. 17 is a flowchart illustrating a third method of optimizing the DNN according to an example embodiment.

FIG. 18 illustrates a block diagram illustrating an example of a machine upon which one or more embodiments may be implemented.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on computing resources, such as a digital signal processor, ASIC, microprocessor, multiple processor unit processor, or other type of processor operating on a local or remote computer system, such as a personal computer, server or other computer system, turning such computer system into a specifically programmed machine.

Despite the great learning capability of DL models, it has been hard to interpret what the important features are for achieving such superb accuracies. In the deep learning literature, the statistical properties of weight matrices, particularly the absolute value of the weights, has been used by researchers as the key indicator of the importance of a synapses or a neuron to guide pruning pre-trained neural networks, regularizing neural networks to improve accuracy, and/or quantizing DL models.

In prior attempts to optimize neural networks, and hence reduce the amount of processing resources to run such networks, an absolute value of weights on neurons of the networks was thought to be a key indicator of the importance of the neurons to reaching a correct result. However, there are several drawbacks in leveraging the absolute value to rank the importance of a neuron in a DNN model that inventors have identified. The absolute value is oblivious to the application data, does not provide a global ranking system as the range of weight values shifts from one layer to the other layer, and accuracy of a DL model does not solely depend on the weight values as shown in Equation 1:

$$Loss = g ( x , {W}^{( 1 )} , {W}^{( 2 )} , … ) , \\ ΔLoss = Σ \frac{δLoss}{δ {W}^{( i )}} Δ {W}^{( i )} + 0.5 Σ \frac{{δ}^{2} Loss}{δ {W}^{{( i )}^{2}}} Δ {W}^{{( i )}^{2}} + … , \qquad ( 1 )$$

where the loss function is a function of both the input data (x) and DL model parameters (W⁽ⁱ⁾). As described in the Equation 1, the accuracy of a model is dependent on the gradient of the corresponding output with respect to each weight and not the absolute value of the weight itself. As such, the absolute value of weights is not an accurate metric to measure the importance of a connection.

In various embodiments of the present inventive subject matter, a neural entropy measurement is used to optimize machine learning, such as deep neural network training and to machine classifiers produced via such training by providing a dynamic measure or quantitative metric of the actual importance of each neuron/synapse in a deep learning (DL) model.

Physical viability in terms of scalability and energy efficiency plays a key role in achieving a sustainable and practical computing system. Deep learning is an important field of machine learning that has provided a significant leap in our ability to comprehend raw data in a variety of complex learning tasks. Concerns over the functionality (accuracy) and physical performance are major challenges in realizing the true potential of DL models. Empirical experiments have been the key driving force behind the success of DL mechanisms with theoretical metrics explaining its behavior yet remaining mainly elusive.

By using a neural entropy measurement, the functionality of DL models may be characterized from an information theoretic and dynamic data-driven statistical learning point of view. The neural entropy measurement, which may be thought of as uncertainty, provides a new quantitative metric to measure the importance/contribution of each neuron and/or synopsis in a given DL model. The characterization, in turn, provides a guideline to optimize the physical performance of DL networks while minimally affecting their functionality (accuracy). In particular, the new quantitative characterization can be leveraged to effectively: (i) prune pre-trained networks while minimizing the required retraining effort to recover the accuracy, (ii) regularize the state-of-the-art DL models with the goal of achieving higher accuracies, (iii) guide the choice of numerical precision for efficient inference realization, and (iv) speed up the DL training time by removing the nuisance variables within the DL network and helping the model converge faster. Such an optimized DL can greatly reduce the processing resources required to both train and use trained DL networks or models for countless practical applications.

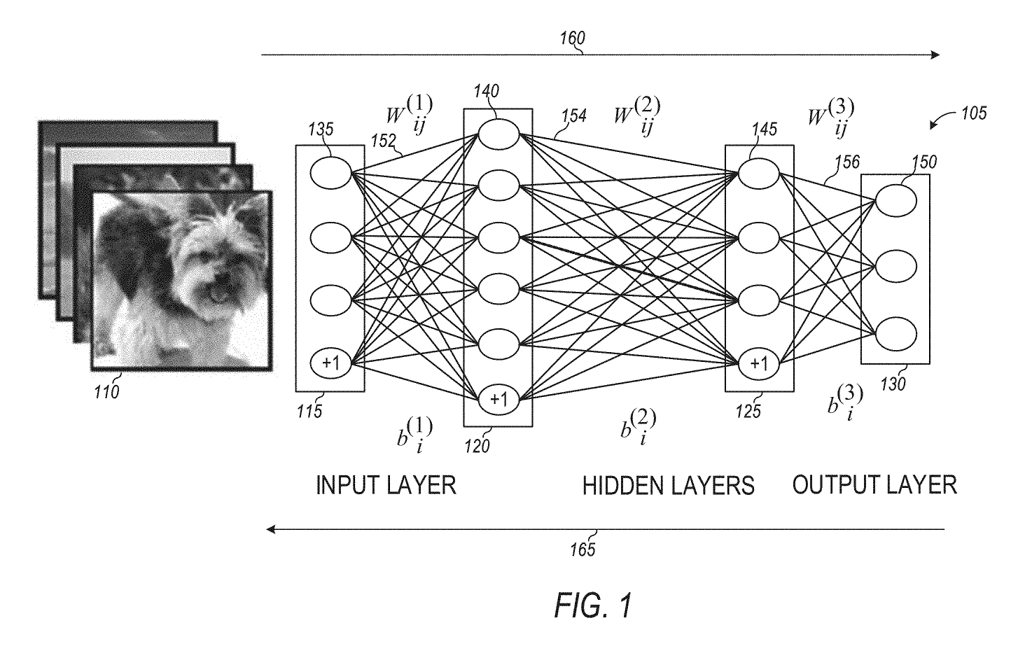

FIG. 1 is a block representation at 100 of training a DL network to form a DL model 105 by use of a training dataset X^{train}, illustrated at dataset 110. Dataset 110 is shown as a set of images of dogs in one example. The dataset 110 may be labeled and may consist of images of other animals or things; data collected from sensors (such as speech through microphones), physical systems, smart manufacturing, or search engines; or many other types of data that may be used to train a DL network for prediction and control. The dataset 110 is used to train a DL network to form the DL model 105. The model 105 in this example includes an input layer 115, hidden layers 120 and 125, and an output layer 130. Each layer contains multiple nodes, with a single node labeled in each layer at 135, 140, 145, and 150 respectively.

Connections between these nodes are indicated at 152, 154, and 156. Training the network may use forward propagation/prediction represented by arrow 160 using equation: xᵢ^{(s+1)}=f(Σⱼ₌₁ⁿ^{^{(s)}}Wᵢⱼ^{(s)}xⱼ^{(s)}+bᵢ^{(s)}), where x is the input and b is a bias node commonly used in various layers of a DL model. Each connection has a weight, with the connections between layers 135 to 140, 140 to 145, and 145 to 150 having weights of Wᵢⱼ⁽¹⁾, Wᵢⱼ⁽²⁾, Wᵢⱼ⁽³⁾ respectively. Backward propagation indicated by arrow 165 may also be performed using equation:

$${W}_{ij}^{( s )} = {W}_{ij}^{( s )} - η \frac{1}{{b}_{s}} {\sum }_{k = 1}^{{b}_{s}} \frac{\partial {Err}^{( s )}}{\partial {W}_{ij}^{( s )}} ) ,$$

to fine tune the model by taking the errors in the predictions into account to adjust the weights. Note that all nodes in successive layers are similarly connected between each other as illustrated by the lines/connections between them.

Instead of using static properties of a DL model such as the absolute value of the weights, dynamic data-driven statistics of the DL model are considered in order to characterize the contribution of each connection and/or neuron in deriving the ultimate result. An element-wise multiplication of the input activations to the i^{th} layer with the corresponding weight matrix (Wⁱ^{^{th}}) is referred to as a spreading signal. Passing the training dataset 110, Xₜᵣₐᵢₙ, through the network (forward pass), the spreading signal at each connection/neuron roughly forms a Gaussian distribution.

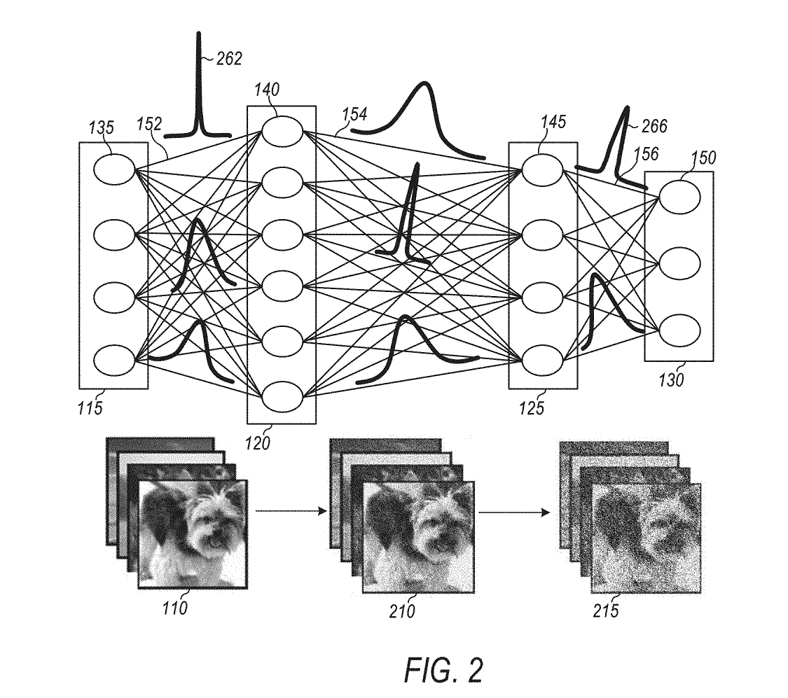

FIG. 2 is a block representation of a DL model 200 illustrating variance of each Gaussian distribution that indicates how much uncertainty may be observed in a particular connection. Reference numbers are used to represent the same elements as in FIG. 1. The training dataset X^{train}, illustrated at 110, is shown as a set of images of dogs in one example. The dataset 110, as it progresses through the layers of the model are shown at 210 and 215. As the input data passes through the network, the nuisance features are removed, and high-level key features are abstracted to derive the final decision (e.g., classification label).

Representations of spreading signals at each connection are shown as Gaussian distributions at 262, 264, and 266 on connections 152, 154, and 156 respectively. A high variance, for example variance 262, implies a considerable uncertainty in a particular connection meaning that firing of that connection is highly dependent on the data that passes through, whereas a low variance indicates that a particular connection is always on or off regardless of the data (low amount of information is carried through that connection). While just a few distributions are show for ease of illustration, each connection may have an associated distribution.

The spreading signal at each connection/neuron roughly follows a Gaussian distribution. Entropy can be interpreted as the exponent of the volume of the supporting set (e.g., area covered by the Gaussian distribution). The variance of each Gaussian distribution indicates how much uncertainty is observed in a particular connection. A high variance implies a considerable uncertainty in a particular connection meaning that firing of that connection is highly dependent on the data that passes through, whereas a low variance indicates that a particular connection is always on or off regardless of the data. In other words, a low amount of information is carried through that connection.

Considering the dynamic Gaussian distribution, h(x), formed at each connection by passing the data through the network, the differential entropy per connection is computed as the following:

$$h ( x ) = - \int f ( x ) log ( f ( x ) ) dx \\ f ( x ) = \frac{1}{\sqrt{2 {πσ}^{2}}} exp ( - \frac{{( x - μ )}^{2}}{2 {σ}^{2}} ) \\ h ( {\tilde{x}}_{ij}^{( l )} ) = \frac{ln ( {σ}_{ij}^{( l )} \sqrt{2 πɛ} )}{ln ( 2 )} bits , \qquad ( 2 )$$

ij where \tilde{x}ᵢⱼ^{(l)} is the random variable formed at the edge connecting the i^{th} neuron in the layer l to the j^{th} neuron in the layer l+1. The entropy, in turn, indicated the required number of bits for effective representation of a connection. As shown, the entropy is independent of the mean value and only depends on the variance of the pertinent Gaussian distribution.

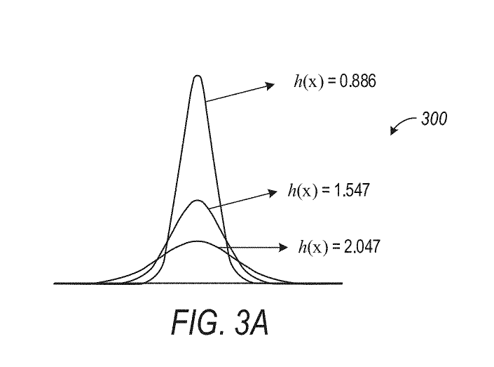

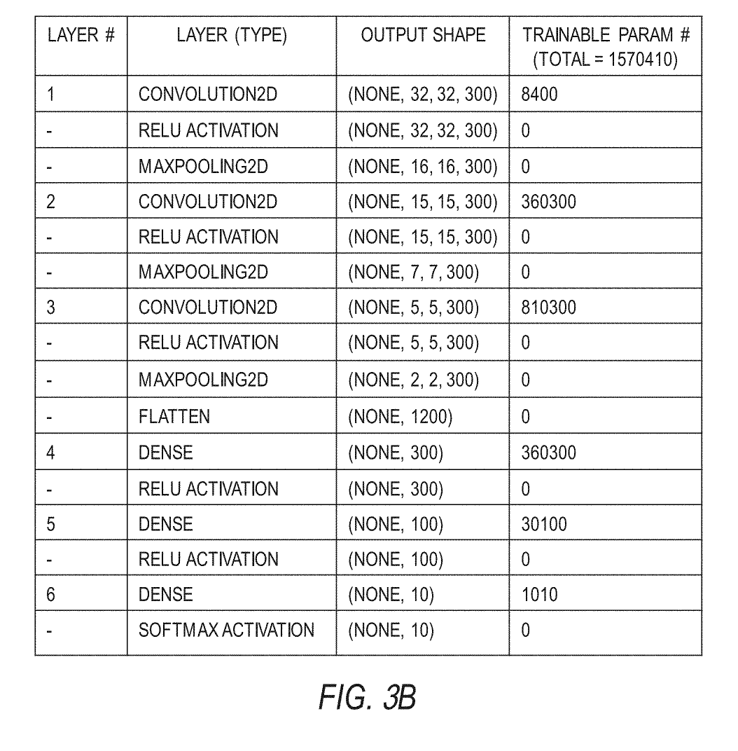

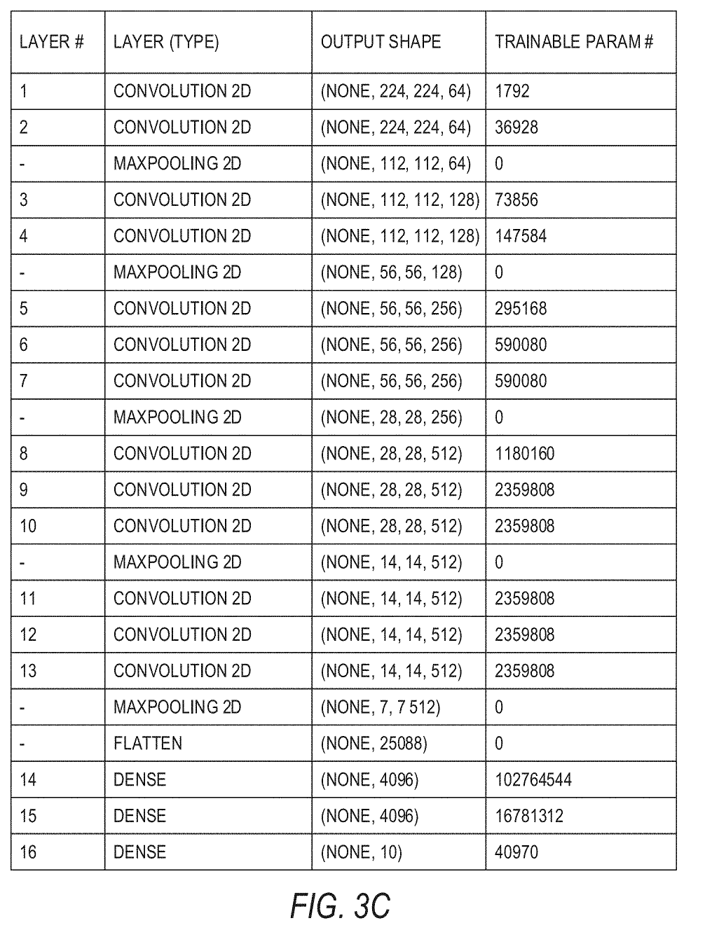

In processing continuous random variable, a negative entropy means the corresponding volume is small (on average there is not much uncertainty in the set). In discrete settings, 2^{h(x)} is the average number of events that happens (2^{h(x)}<|X|), where |X| is the number of elements in the set. In continuous settings, a negative entropy means that the corresponding value is small. On average, there isn't much uncertainty in the set as illustrated in FIG. 3A showing various Gaussian distributions versus variance at 300 (the numbers next to each curve represents the corresponding entropy of that curve). The entropy per connection is leveraged as a key indicator of the importance of each parameter and may be used to lead pruning of pre-trained models, regularize DL models to improve accuracy and generalize properties, and guide the choice of numerical precision as discussed below.

Image and video datasets encompass the majority of the generated content in the modern digital world. Canadian Institute for Advanced Research CIFAR10 image data may be used as an example benchmark to validate use of an entropy measure in analyzing and optimizing training of DL networks. The CIFAR10 data is a collection of 60000 color images of size 32×32 pixels that are classified in 10 categories: Airplane, Car, Bird, Cat, Deer, Dog, Frog, Horse, Ship, and Truck. In one example, a multi-column deep neural network for image classification topology may be trained and used as benchmark 1, and a very deep convolutional network for large scale image recognition may be trained and used as benchmark 2 for the CIFAR10 dataset. Benchmark 1 is a 6-layer Convolutional Neural Network (CNN) with more than 1.5 million parameters as shown in FIG. 3B. Benchmark 2 is a 16-layer CNN model (known as VGG16) with more than 134 million parameters as shown in FIG. 3C.

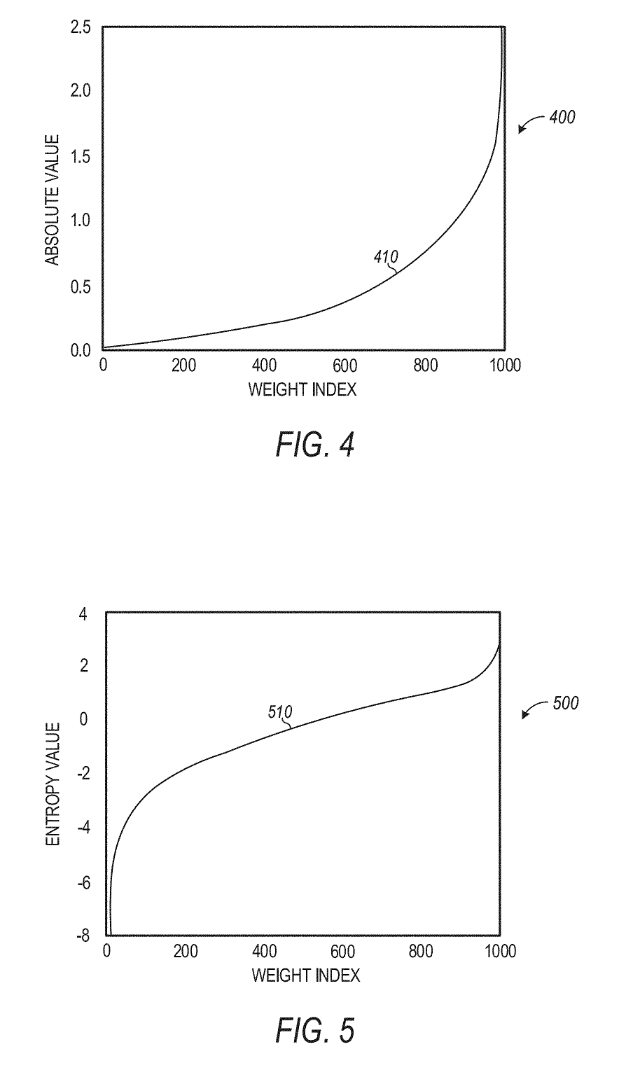

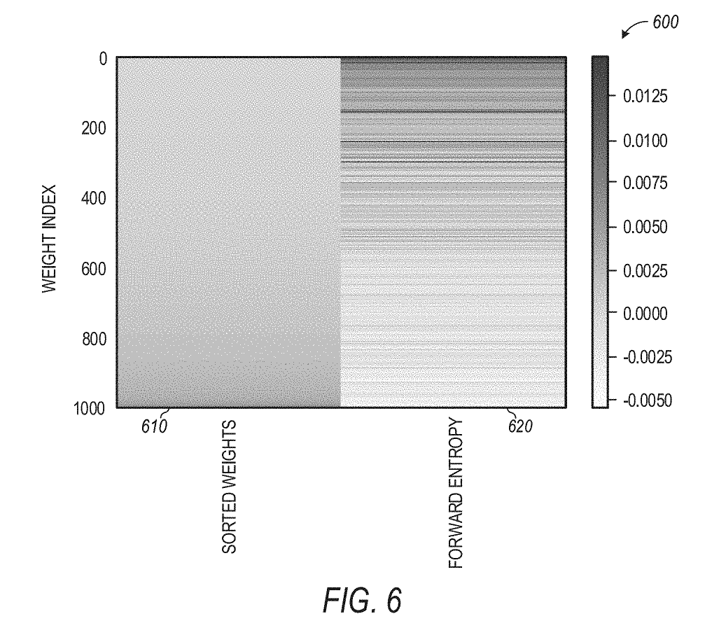

FIG. 4 is a graph 400 illustrating sorted absolute value of the weights by curve 410 versus a weight index in the layer 6 (output layer) of benchmark 1, and FIG. 5 is a graph 500 illustrating sorted entropy by curve 510 of the weights versus weight index in the same layer. Each connection (weight) is indexed by a label which is referred to as the weight index. The weight index is a positive natural number showing the relative importance (rank) of a particular weight in comparison with other connections. FIG. 6 is a graph 600 illustrating the absolute value of a weight at curve 610 and its entropy at curve 620 are not necessarily correlated.

The sorted entropy curve 510 and the absolute value of weights 410 for layer 6 (output layer) of benchmark 1 are not necessarily correlated.

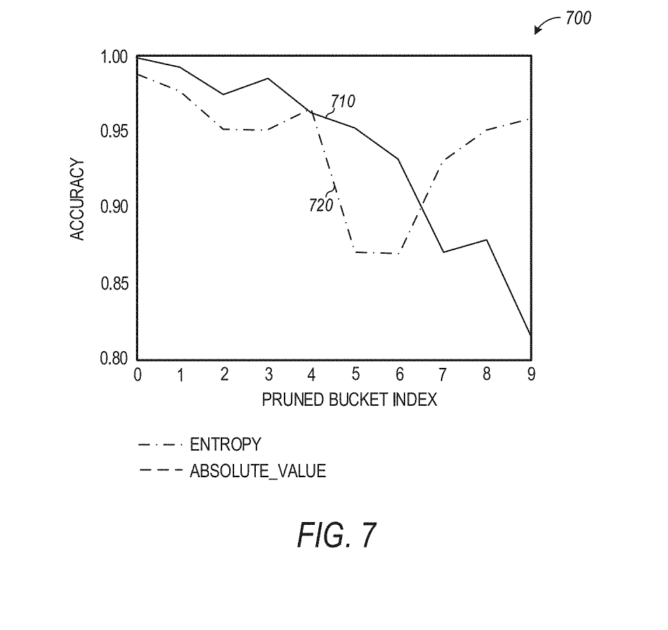

FIG. 7 is a graph 700 illustrating a ranking of the weights based on their entropy at curve 710 and absolute value at 720 and dividing the sorted weights into 10 different buckets. Dropping one bucket of the sorted weights at a time impacts the overall accuracy (with no retraining). The accuracy drop corresponds to the model accuracy after pruning without retraining. As demonstrated by curves 710 and 720, entropy provides a better ranking approach to index the weights based on their importance.

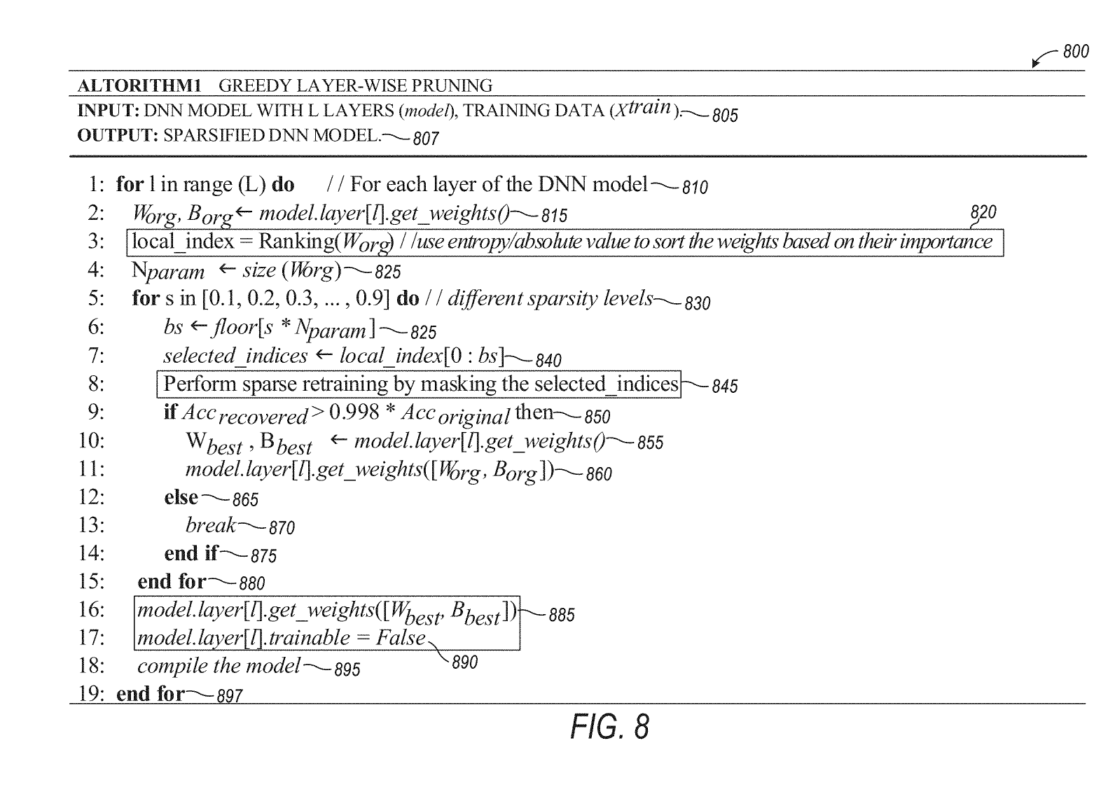

FIG. 8 is a pseudocode representation of a greedy layer-wise pruning algorithm indicated at 800. Both entropy and the absolute value of the weights are leveraged to greedily prune a pre-trained DL model with L layers using training data X^{train} as inputs indicated at 805. The output is identified as a sparsified DNN model at 807. The algorithm 800 is performed for L layers, layer by layer, 1 while 1 is in range L as indicated at 810. The weights for each layer are obtained at 815 and the entropy/absolute value is used to sort the weights based on their importance beginning at 820.

At 825, the ranked weights are imported into a parameter matrix N, and then a loop is performed starting at 830 using different sparsity levels, s, for the current layer, 1. Selected indices are identified at 835 and 840, and sparse retraining is performed by masking the selected indices beginning at 845.

At 850, 855, and 860, the accuracy of the sparse model layers are compared to the accuracy of the model prior to pruning to determine the best accuracy of the sparsely trained layer and set the weights for the model layers. If no sparse layer accuracy was sufficient, none is selected as indicated at 865 and 870. Loops are ended at 875 and 880. Model layer weights are set at 885 and an indication that the layer is trainable is set to False at 890. The model is compiled at 895, and the algorithm 800 ends at 897.

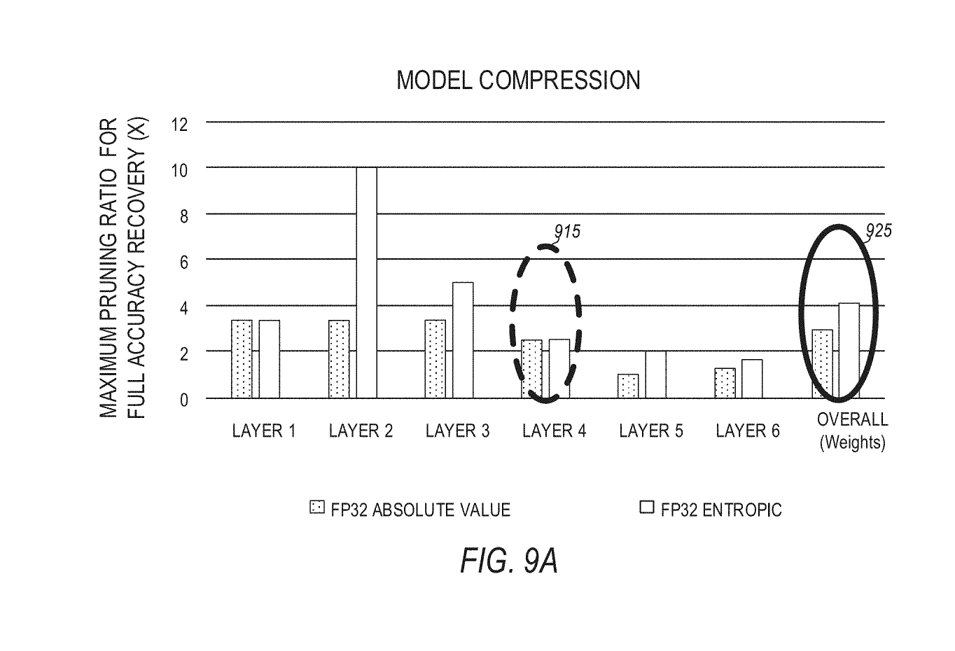

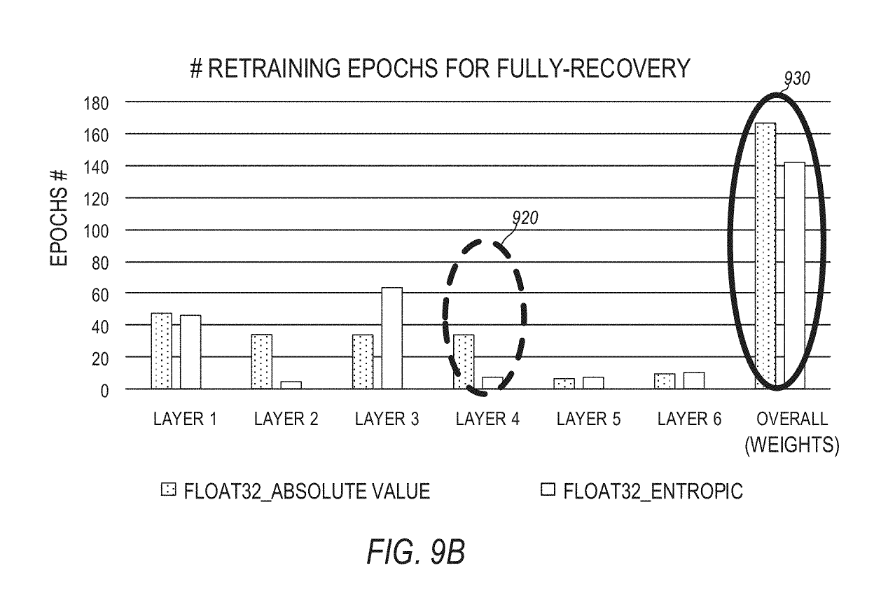

FIG. 9A is a bar chart showing model compression in each layer of benchmark 1 at 900 after sparse retraining to recover original accuracy. Pairs of bars are shown for each layer, with the first bar corresponding to absolute value and the second corresponding to entropic ranking. The height of each bar corresponds to a maximum pruning ratio for full accuracy recovery. FIG. 9B is a similar bar chart 910 showing the number of retraining epochs, or sessions used to recover the original accuracy after pruning each layer. Entropic ranking can result in either (i) a higher compression rate (e.g., layer 2) per layer, or (ii) less number of retraining epochs to fully recover the target accuracy with the same compression ratio (e.g., layer 4 circled at 915 and 920). Overall weights in both figures are circled at 925 and 930 at the end of the x-axis.

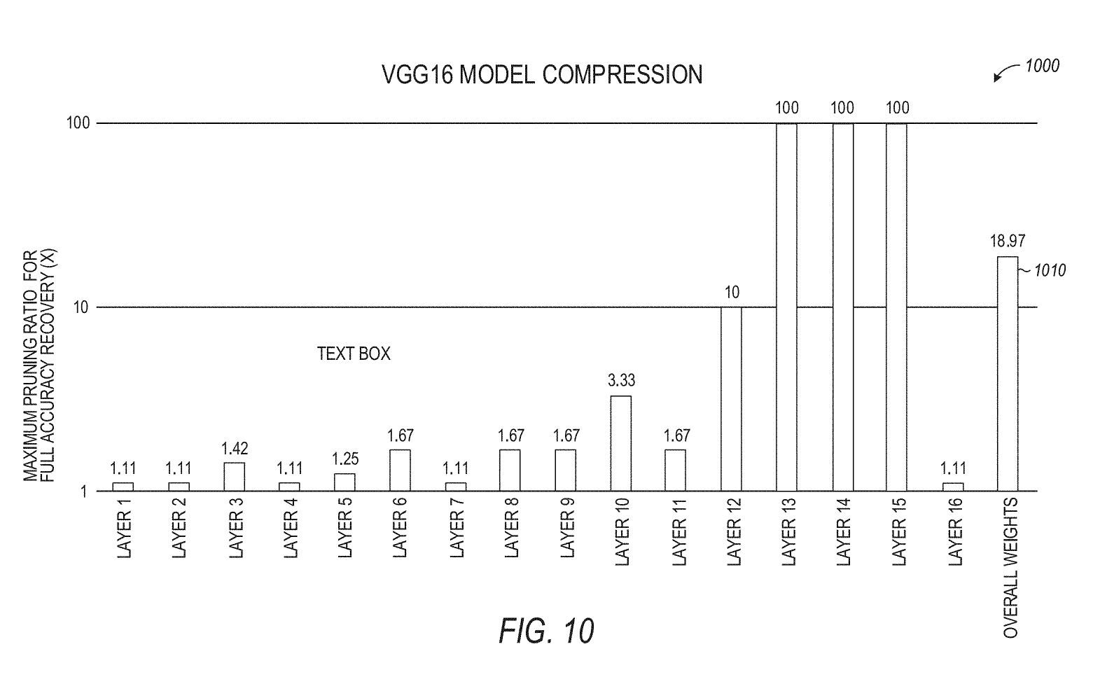

FIG. 10 is a bar chart 1000 illustrating the result of pruning benchmark 2 using the entropic approach. The height of each bar represents the maximum pruning ratio for full accuracy recovery for each layer with the y-axis shown in logarithmic scale. Overall weights are shown at bar 1010.

In some embodiments, accuracy during training may be improved using the entropic measures. Significant redundancy exists in the state-of-art DL models. These redundancies, in turn, highlight the inadequacy of current training methods making it necessary to design regularization methods in order to effectively remove nuisance variables. Use of regularization techniques in training DL models can generally lead to a better accuracy by avoiding over-fitting or introducing additional information to the system. Two commonly used regularization techniques are (i) dimensionality reduction (thinning) by removing unimportant neurons and (ii) inducing sparsity to a dense DL network, train the sparse model, and re-dense the model again. Entropic analysis of neural network can be used to guide both the aforementioned regularization approaches leading to superior results compared to the conventional approach.

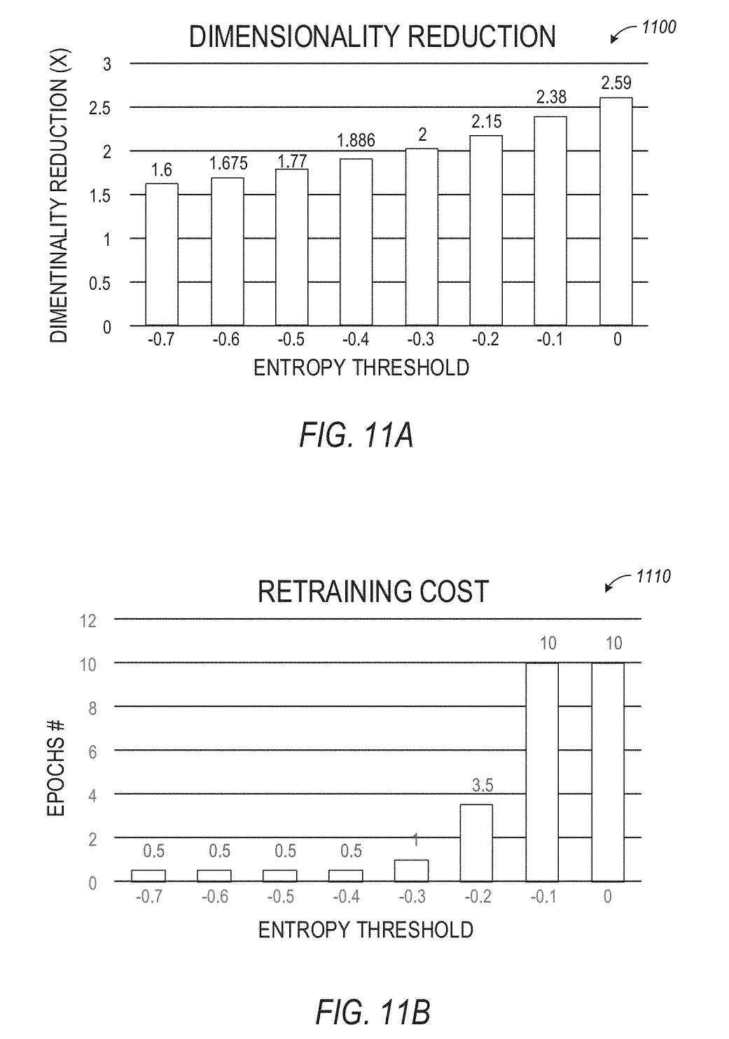

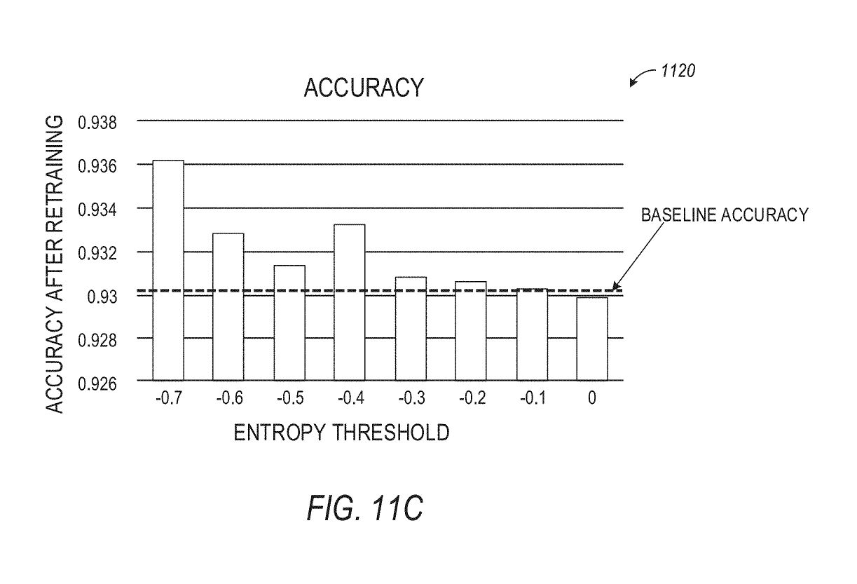

In a first approach, entropy may be used to guide dimensionality reduction in neural networks by highlighting the importance of each neuron (unit) based on the variance of the signal passing through. The dimensionality reduction of the VGG16 network (benchmark 2) based on different levels of entropic thresholding is shown at 1100 in bar chart form in FIG. 11A. FIG. 11B is a bar chart illustrating the number of retraining epochs required to fully recover the original accuracy after thinning with different entropic thresholds generally at 1110. FIG. 11C is a bar chart illustrating the obtained accuracy after thinning and retraining the pruned network at different entropic thresholds generally at 1120. As demonstrated, entropic analysis of neural networks can be effectively used to regularize the underlying model and improved its generalization properties (accuracy).

A second regularization approach used in the context of deep learning is Dense Sparse Dense (DSD) training procedure performed on pre-trained neural networks. The second approach involves three main steps: (i) pruning least important synapses to induce sparsity in the pertinent network (ii) fine-tuning the pruned network by sparsely retraining the model (iii) removing the sparsity constraint (re-dense the model) and retrain the network while including all the removed synapses from step 1. The pruning phase (step 1) may be performed using both absolute value of the weights (referred to as DSD) and the entropy of each connection (referred to as DED).

Table 1 compares the results of DED versus DSD in both benchmarks. As shown, for the same number of training epochs DED method outperforms the conventional DSD approach by removing the less entropic weights. For the same number of training epochs, the DED method outperforms the conventional DSD approach by removing the less entropic weights.

TABLE 1

| | | | DSD | DED |
|---|---|---|---|---|
| | DSD | DED | Improvement | Improvement |
| Benchmark 1 | 81.35% | 82.93% | 1.3% | 2.88% |
| Benchmark 2 | 93.78% | 94.05% | 0.74% | 1.01% |

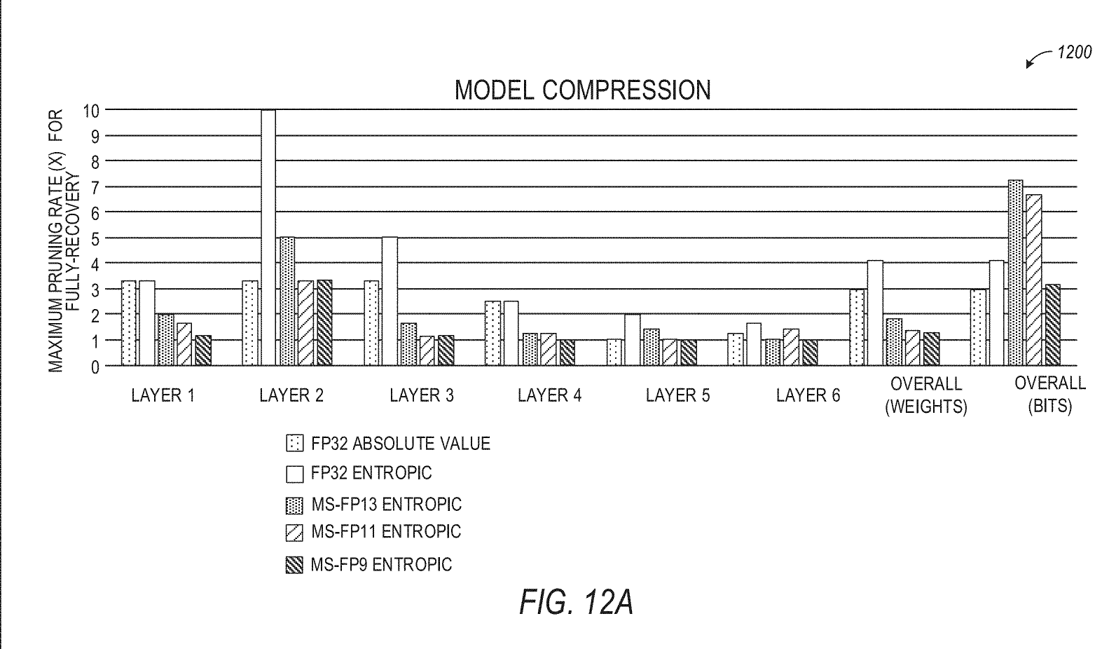

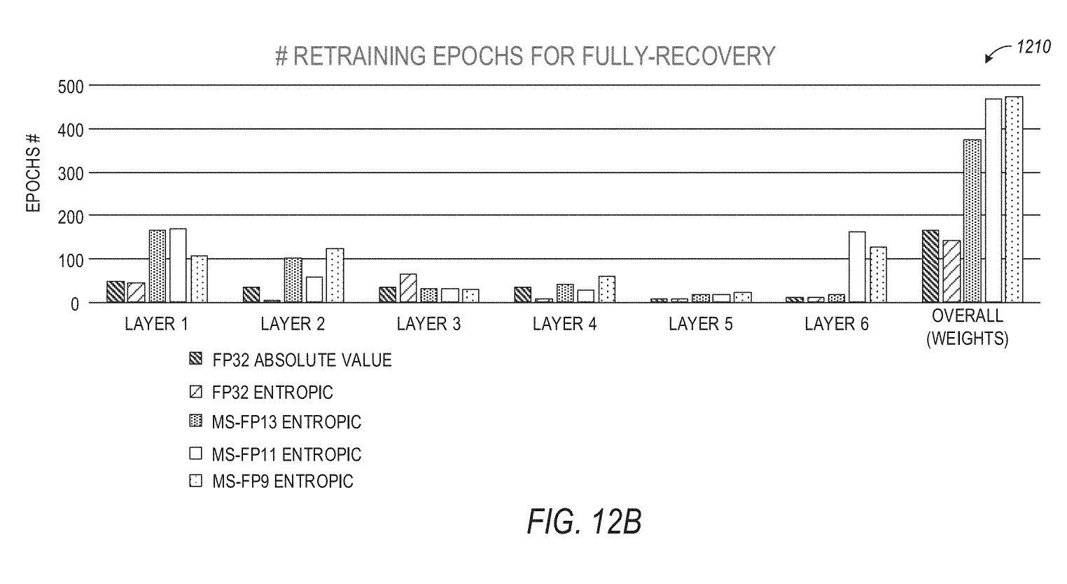

FIG. 12A is a bar chart illustrating at 1200, a maximum pruning rate per layer while enforcing a particular numerical format. The sets of five bars from right to left correspond to 32 bit floating point absolute values, 32 bit floating point entropic values, Microsoft floating point format (ms-fp13) entropic values, ms-fp11 entropic values, and ms-fp9 entropic values. The number of re-training epochs to fully recover the original accuracy is depicted in FIG. 12B in bar chart form at 1210, with the sets of bars corresponding to the same numerical formats as in FIG. 12A. As shown, there is a trade-off between the total number of parameters in a particular layer and the number of bits used to represent each parameter. This trade-off can be, in turn, leveraged to determine the most energy-efficient configuration considering the computational cost for a particular numerical format and the required number of weights in that numerical precision.

Training of a DL model involves two main phases: fitting and compression. The fitting phase is usually faster (requiring less number of epochs) while most of the training time is spent in the compression phase to remove the nuisance variables that are irrelevant to the decision space. The entropic quantitative metric can be, in turn, incorporated within the loss function of underlying model in order to expedite the process of removing unnecessary/unimportant connections (synapses) by enforcing temporary sparsity in the network.

The entropic quantitative metric can be leveraged to evaluate the effective capacity of the DL model at each training epoch. The quantitative measurement of the effective learning capacity, in turn, enables dynamic adjustment of the DL model topology during the training phase in order to best fit the data structure (achieve the best accuracy) while minimizing the required computational resources (in terms of number of FLOPs and/or energy consumption).

An automated analytical system may be used to explore the trade-off between the number of required weights (parameters) and the numerical precision of a DL model to achieve a particular accuracy. The system, may be used to customize the number of parameters per layer and the appropriate numerical precision based on the corresponding entropy curve of each DL layer. The output of the customization system can be leveraged to determine the most energy-efficient configuration considering the computational cost for a particular numerical format and the required number of weights in that precision to obtain a certain level of accuracy.

The entropic quantitative metric may also be used to provide analytical guidelines to effectively train DL models to get the most out of designated computational resources. Algorithms and APIs may be used to facilitate the conversion of a given model to different numerical formats, enabling enforcing the entropy curve to adhere to a uniform distribution over all the connections of each layer while adjusting the entropy level to fully preserve the accuracy. The enforced uniform distribution ensures that every bit of computation contributes to the final accuracy (the maximum usage is obtained from the available resource provisioning), while the magnitude of entropy per connection indicates the minimum number of bits which may be used to represent each parameter to avoid any drop in the accuracy.

Most entropic quantities are discrete in nature. However, the world is continuous, such as noise. In one embodiment utilizing quantization and differential entropy, a continuous domain, x, is divided into bins of length Δ=2⁻ⁿ. Then, H(X^{Δ})≈h(x)−log Δ≈h(x)+n. H(X^{Δ}) is the number of bits, on average, required to describe x to n-bit accuracy. For example, consider x˜U [0, 1/8] with h(x)=−3. The first 3 bits to the right of the decimal point are 0. To describe x to n-bit accuracy requires only n=3 bits.

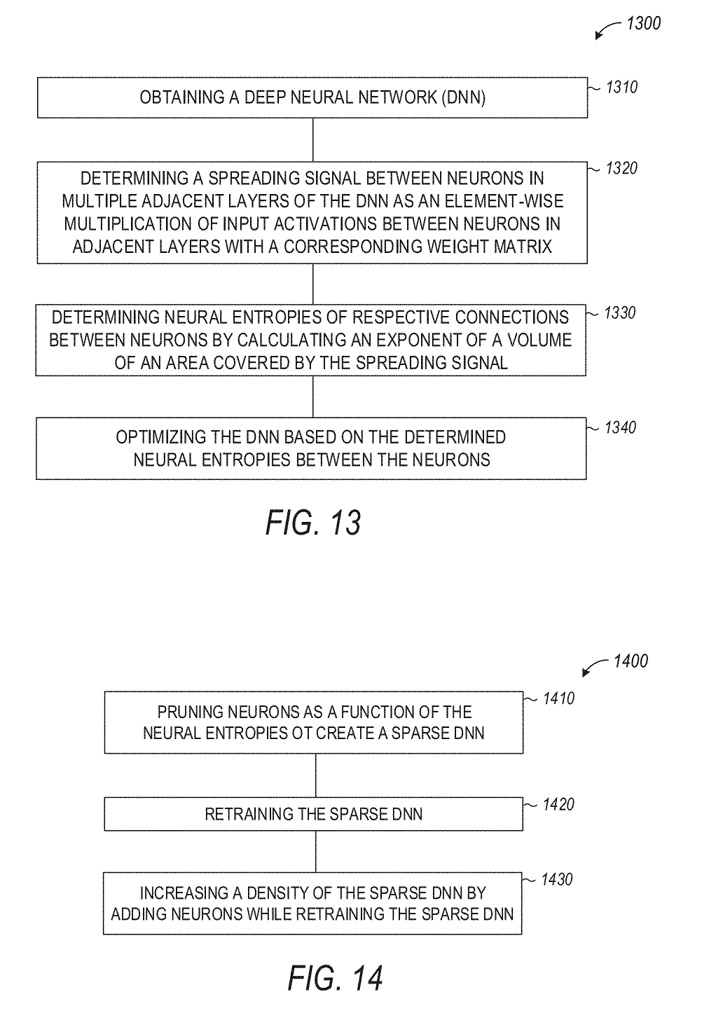

FIG. 13 is a flowchart illustrating a method 1300 of training a DNN and determining entropic measurements for neuron connections in intermediate and final forms of the resulting model. Method 1300 may be a computer implemented method of optimizing machine learning that may be used with a trained DNN or while training the DNN with a training dataset as indicated at operation 1310. The trained DNN may be partially trained or fully trained using the training dataset. Obtaining a trained DNN may be performed by retrieving the trained DNN from a local or remote storage device or other device, or by at least training an untrained DNN with a desired dataset. A spreading signal between neurons in multiple adjacent layers of the DNN is determined at operation 1320. The spreading signal is an element-wise multiplication of input activations between the neurons in a first layer to neurons in a second next layer with a corresponding weight matrix of connections between such neurons as described in further detail above. Operation 1330 determines neural entropies of respective connections between neurons by calculating an exponent of a volume of an area covered by the spreading signal. The DNN may be optimized at operation 1340 based on the determined neural entropies between the neurons in the multiple adjacent layers.

The entropy shows how much signal is passing through each connection to derive the final decision in a neural network. For instance, if a connection is in charge of detecting a curve line that is ubiquitous among all input samples, that connection is not critical and incur a low entropy. As such, it can be safely removed since it technically measures a nuisance variable. Whereas, if we have a high entropy connection, it means that connection carries information about particular features and is inactive for other features. Thereby, such connections (weights) are critical to distinguish different classes of data and perform effective inference.

FIG. 14 is a flowchart illustrating a first method 1400 of optimizing the DNN. Operation 1410 prunes neurons as a function of the neural entropies to create a sparse DNN. The sparse DNN may be retrained at operation 1420 while increasing the density of the sparse DNN by adding neurons during the retraining as indicated by operation 1430. Pruning via operation 1410 may be performed using a greedy layer-wise pruning based on entropic ranking to remove less entropic connections.

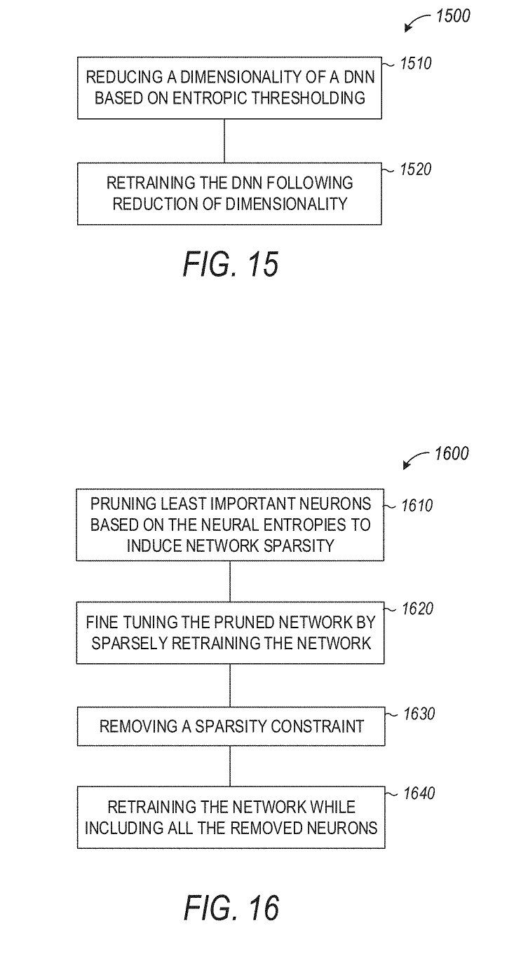

FIG. 15 is a flowchart illustrating a second method 1500 of optimizing the DNN comprises regularization of the DNN during training as a function of the neural entropies. Operation 1510 reduces a dimensionality of a DNN based on entropic thresholding. The dimensionality reduction is followed by retraining the DNN via operation 1520.

FIG. 16 is a flowchart illustrating a second method 1600 of performing regularization of the DNN. Method 1600 begins with operation 1610 where least important neurons are pruned based on the neural entropies to induce network sparsity. The pruned network is then fine-tuned at operation 1620 by sparsely retraining the network. A sparsity constraint is then removed at operation 1630 and operation 1640 retrains the network while including the removed neurons.

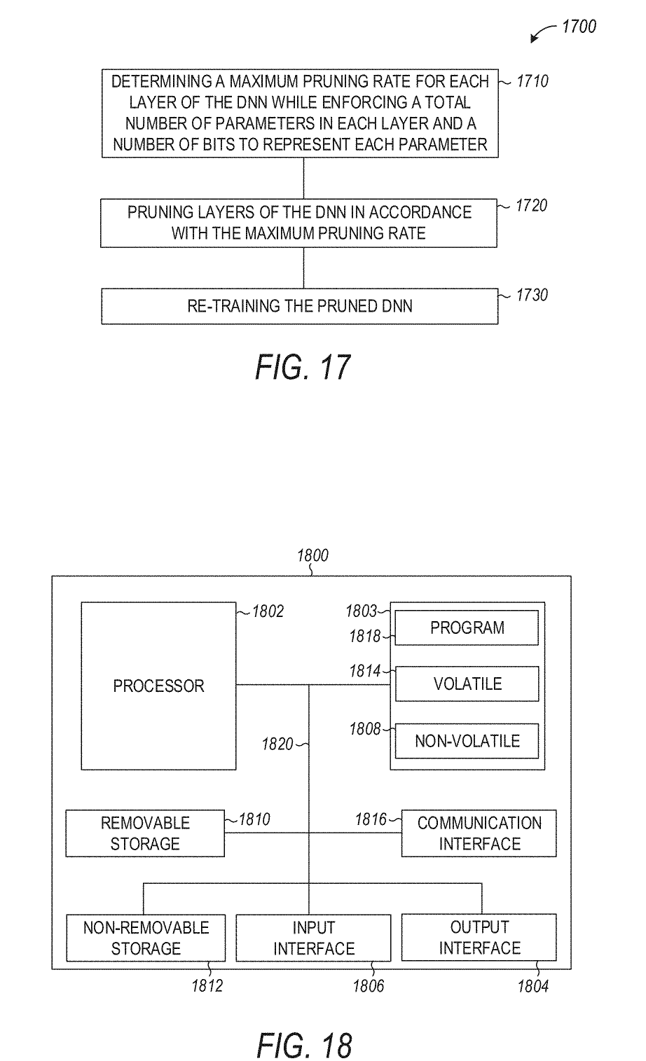

FIG. 17 is a flowchart illustrating a third method 1700 of optimizing the DNN. Method 1700 begins by operation 1710 determining a maximum pruning rate for each layer of the DNN while enforcing a total number of parameters in each layer and a number of bits to represent each parameter. Layers of the DNN are pruned by operation 1720 in accordance with the maximum pruning rate. Re-training the pruned DNN is performed via operation 1730.

Further techniques for optimizing the DNN include removing nuisance variables within the DL network as a function of the determined entropies while training the DL network, and guiding training of a neural network to determine the size of each layer based on the determined entropies.

FIG. 18 is a block diagram illustrating circuitry for determining entropy measurements for deep learning networks and using entropy metrics for optimizing the DL models as well as training of the DL modes, and performing other methods according to example embodiments. All components need not be used in various embodiments.

One example computing device in the form of a computer 1800 may include a processing unit 1802, memory 1803, removable storage 1810, and non-removable storage 1812. Although the example computing device is illustrated and described as computer 1800, the computing device may be in different forms in different embodiments. For example, the computing device may instead be a smartphone, a tablet, smartwatch, or other computing device including the same or similar elements as illustrated and described with regard to FIG. 18. Devices, such as smartphones, tablets, and smartwatches, are generally collectively referred to as mobile devices or user equipment. Further, although the various data storage elements are illustrated as part of the computer 1800, the storage may also or alternatively include cloud-based storage accessible via a network, such as the Internet or server based storage.

Memory 1803 may include volatile memory 1814 and non-volatile memory 1808. Computer 1800 may include, or have access to a computing environment that includes, a variety of computer-readable media, such as volatile memory 1814 and non-volatile memory 1808, removable storage 1810 and non-removable storage 1812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1800 may include or have access to a computing environment that includes input interface 1806, output interface 1804, and a communication interface 1816. Output interface 1804 may include a display device, such as a touchscreen, that also may serve as an input device. The input interface 1806 may include one or more of a touchscreen, touchpad, mouse, keyboard, camera, one or more device-specific buttons, one or more sensors integrated within or coupled via wired or wireless data connections to the computer 1800, and other input devices. The computer may operate in a networked environment using a communication connection to connect to one or more remote computers, such as database servers. The remote computer may include a personal computer (PC), server, router, network PC, a peer device or other common DFD network switch, or the like. The communication connection may include a Local Area Network (LAN), a Wide Area Network (WAN), cellular, WiFi, Bluetooth, or other networks. According to one embodiment, the various components of computer 1800 are connected with a system bus 1820.

Computer-readable instructions stored on a computer-readable medium are executable by the processing unit 1802 of the computer 1800, such as a program 1818. The program 1818 in some embodiments comprises software that, when executed by the processing unit 1802, performs operations according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 1818 may be used to cause processing unit 1802 to perform one or more methods or algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

### OTHER NOTES AND EXAMPLES

Example 1 is a computer implemented method of optimizing a neural network that includes obtaining a deep neural network (DNN) trained with a training dataset, determining a spreading signal between neurons in multiple adjacent layers of the DNN wherein the spreading signal is an element-wise multiplication of input activations between the neurons in a first layer to neurons in a second next layer with a corresponding weight matrix of connections between such neurons, and determining neural entropies of respective connections between neurons by calculating an exponent of a volume of an area covered by the spreading signal.

In Example 2, the subject matter of Example 1 optionally includes optimizing the DNN based on the determined neural entropies between the neurons in the multiple adjacent layers.

In Example 3, the subject matter of any of the previous examples optionally includes wherein optimizing the DNN comprises pruning neurons as a function of the neural entropies to create a sparse DNN.

In Example 4, the subject matter of any of the previous examples optionally includes retraining the sparse DNN.

In Example 5, the subject matter of any of the previous examples optionally includes increasing a density of the sparse DNN by adding neurons while retraining the sparse DNN.

In Example 6, the subject matter of any of the previous examples optionally includes wherein pruning is performed using a greedy layer-wise pruning based on entropic ranking to remove less entropic connections.

In Example 7, the subject matter of any of the previous examples optionally includes wherein optimizing the DNN comprises regularization of the DNN during training as a function of the neural entropies.

In Example 8, the subject matter of any of the previous examples optionally includes wherein regularization comprises reducing a dimensionality of a DNN based on entropic thresholding, and retraining the DNN following reduction of dimensionality.

In Example 9, the subject matter of any of the previous examples optionally includes wherein regularization comprises pruning least important neurons based on the neural entropies to induce network sparsity, fine tuning the pruned network by sparsely retraining the network, removing a sparsity constraint, and retraining the network while including all the removed neurons.

In Example 10, the subject matter of any of the previous examples optionally includes wherein optimizing the DNN comprises determining a maximum pruning rate for each layer of the DNN while enforcing a total number of parameters in each layer and a number of bits to represent each parameter, pruning layers of the DNN in accordance with the maximum pruning rate, and re-training the pruned DNN.

In Example 11, the subject matter of any of the previous examples optionally includes wherein optimizing the DNN comprises removing nuisance variables within the DL network as a function of the determined entropies while training the DL network.

In Example 12, the subject matter of any of the previous examples optionally includes wherein optimizing the DNN comprises guiding training of the multi-layer DNN to determine a size of each layer.

In Example 13, a computing device, includes a processor and a memory, the memory comprising instructions, which when executed by the processor, cause the processor to perform operations comprising obtaining a deep neural network (DNN) trained with a training dataset, determining a spreading signal between neurons in multiple adjacent layers of the DNN wherein the spreading signal is an element-wise multiplication of input activations between the neurons in a first layer to neurons in a second next layer with a corresponding weight matrix of connections between such neurons, and determining neural entropies of respective connections between neurons by calculating an exponent of a volume of an area covered by the spreading signal.

In Example 14, the subject matter of any of the previous examples optionally includes wherein the operations further comprise optimizing the DNN based on the determined neural entropies between the neurons in the multiple adjacent layers.

In Example 15, the subject matter of any of the previous examples optionally includes wherein optimizing the DNN comprises pruning neurons as a function of the neural entropies to create a sparse DNN and wherein the operations further comprise retraining the sparse DNN and increasing a density of the sparse DNN by adding neurons while retraining the sparse DNN.

In Example 16, the subject matter of any of the previous examples optionally includes wherein optimizing the DNN comprises regularization of the DNN during training as a function of the neural entropies by reducing a dimensionality of a DNN based on entropic thresholding and retraining the DNN following reduction of dimensionality.

In Example 17, the subject matter of any of the previous examples optionally includes wherein optimizing the DNN comprises determining a maximum pruning rate for each layer of the DNN while enforcing a total number of parameters in each layer and a number of bits to represent each parameter, pruning layers of the DNN in accordance with the maximum pruning rate, and re-training the pruned DNN.

In Example 18, a machine readable medium has instructions which when executed by a processor, cause the processor to perform operations comprising obtaining a deep neural network (DNN) with a training dataset, determining a spreading signal between neurons in multiple adjacent layers of the DNN wherein the spreading signal is an element-wise multiplication of input activations between the neurons in a first layer to neurons in a second next layer with a corresponding weight matrix of connections between such neurons, and determining neural entropies of respective connections between neurons by calculating an exponent of a volume of an area covered by the spreading signal.

In Example 19, the subject matter of any of the previous examples optionally includes wherein the operations further comprise optimizing the DNN based on the determined neural entropies between the neurons in the multiple adjacent layers.

In Example 20, the subject matter of any of the previous examples optionally includes wherein optimizing the DNN comprises pruning neurons as a function of the neural entropies to create a sparse DNN and wherein the operations further comprise retraining the sparse DNN and increasing a density of the sparse DNN by adding neurons while retraining the sparse DNN.

In Example 21 a method of dense-sparse-dense training for a deep learning (DL) network includes training the DNN during a first dense training phase, pruning unimportant neurons based on a neural entropy measure during a sparse training phase, increasing density of the DNN by adding neurons, and re-training the increased density DNN during a second dense training phase.

What is claimed is:

1. A computer implemented method of optimizing a neural network, the method including operations comprising:
obtaining a deep neural network (DNN) trained with a training dataset;
determining a spreading signal between neurons in multiple adjacent layers of the DNN wherein the spreading signal is an element-wise multiplication of input activations between the neurons in a first layer to neurons in a second next layer with a corresponding weight matrix of connections between such neurons; and
determining neural entropies of respective connections between neurons by calculating an exponent of a volume of an area covered by the spreading signal.

2. The method of claim 1 and further comprising optimizing the DNN based on the determined neural entropies between the neurons in the multiple adjacent layers.

3. The method of claim 2 wherein optimizing the DNN comprises pruning neurons as a function of the neural entropies to create a sparse DNN.

4. The method of claim 3 and further comprising retraining the sparse DNN.

5. The method of claim 4 and further comprising increasing a density of the sparse DNN by adding neurons while retraining the sparse DNN.

6. The method of claim 3 wherein pruning is performed using a greedy layer-wise pruning based on entropic ranking to remove less entropic connections.

7. The method of claim 2 wherein optimizing the DNN comprises regularization of the DNN during training as a function of the neural entropies.

8. The method of claim 7 wherein regularization comprises:
reducing a dimensionality of a DNN based on entropic thresholding; and
retraining the DNN following reduction of dimensionality.

9. The method of claim 7 wherein regularization comprises:
pruning least important neurons based on the neural entropies to induce network sparsity;
fine tuning the pruned network by sparsely retraining the network;
removing a sparsity constraint; and
retraining the network while including all the removed neurons.

10. The method of claim 2 wherein optimizing the DNN comprises:
determining a maximum pruning rate for each layer of the DNN while enforcing a total number of parameters in each layer and a number of bits to represent each parameter;
pruning layers of the DNN in accordance with the maximum pruning rate; and
re-training the pruned DNN.

11. The method of claim 2 wherein optimizing the DNN comprises removing nuisance variables within the DL network as a function of the determined entropies while training the DL network.

12. The method of claim 2 wherein optimizing the DNN comprises guiding training of the multi-layer DNN to determine a size of each layer.

13. A computing device, comprising:
a processor;
a memory, the memory comprising instructions, which when executed by the processor, cause the processor to perform operations comprising:
obtaining a deep neural network (DNN) with a training dataset;
determining a spreading signal between neurons in multiple adjacent layers of the DNN wherein the spreading signal is an element-wise multiplication of input activations between the neurons in a first layer to neurons in a second next layer with a corresponding weight matrix of connections between such neurons; and
determining neural entropies of respective connections between neurons by calculating an exponent of a volume of an area covered by the spreading signal.

14. The computing device of claim 13 wherein the operations further comprise optimizing the DNN based on the determined neural entropies between the neurons in the multiple adjacent layers.

15. The computing device of claim 14 wherein optimizing the DNN comprises pruning neurons as a function of the neural entropies to create a sparse DNN and wherein the operations further comprise retraining the sparse DNN and increasing a density of the sparse DNN by adding neurons while retraining the sparse DNN.

16. The computing device of claim 14 wherein optimizing the DNN comprises regularization of the DNN during training as a function of the neural entropies by:
reducing a dimensionality of a DNN based on entropic thresholding; and
retraining the DNN following reduction of dimensionality.

17. The computing device of claim 14 wherein optimizing the DNN comprises:
determining a maximum pruning rate for each layer of the DNN while enforcing a total number of parameters in each layer and a number of bits to represent each parameter;
pruning layers of the DNN in accordance with the maximum pruning rate;
and
re-training the pruned DNN.

18. A machine readable medium having instructions which when executed by a processor, cause the processor to perform operations comprising:
obtaining a deep neural network (DNN) with a training dataset;
determining a spreading signal between neurons in multiple adjacent layers of the DNN wherein the spreading signal is an element-wise multiplication of input activations between the neurons in a first layer to neurons in a second next layer with a corresponding weight matrix of connections between such neurons; and
determining neural entropies of respective connections between neurons by calculating an exponent of a volume of an area covered by the spreading signal.

19. The computing device of claim 18 wherein the operations further comprise optimizing the DNN based on the determined neural entropies between the neurons in the multiple adjacent layers.

20. The computing device of claim 14 wherein optimizing the DNN comprises pruning neurons as a function of the neural entropies to create a sparse DNN and wherein the operations further comprise retraining the sparse DNN and increasing a density of the sparse DNN by adding neurons while retraining the sparse DNN.
